(19) United States
(12) Patent Application Publication
(10) Pub. No.: US 2008/0166960 A1
(43) Pub. Date: Jul. 10, 2008

(54) Poultry Processing Hub And Belt Assembly

(75) Inventor: Robert Clarke, Rogers, AR (US)

Correspondence Address: LATHROP & GAGE LC, 2345 GRAND AVENUE, SUITE 2800, KANSAS CITY, MO, 64108, US

(73) Assignee: MEMCO, Hollister, MO (US)

(21) Appl. No.: 11/932,124

(22) Filed: Oct. 31, 2007

Related U.S. Application Data
(63) Continuation-in-part of application No. 11/615,446, filed on Dec. 22, 2006.
Application No. 11/615,446 is a division of application No. 10/346,257, filed on Jan. 17, 2003, now Pat. No. 7,175,516.
(60) Provisional application No. 60/349,526, filed on Jan. 18, 2002.

(51) Int. Cl. A22C 21/02; F16C 19/00; F16J 15/00; F16H 7/00

(52) U.S. Cl. 452/83; 384/91; 277/345; 474/153

(57) ABSTRACT

A hub and belt assembly for driving a poultry de-feathering machine includes multiple bearing heat dissipating hub that includes bearing isolators or spacers associated with each of the drive shaft bearings. The bearing isolators trap vapors, including water and the like that may accumulate from operation of the hub and belt assembly, and prevent this vapor from contacting the bearings.

### CROSS-REFERENCE TO RELATED APPLICATIONS

This application is a continuation-in-part of U.S. Ser. No. 11/615,446, filed Dec. 22, 2006, which is a divisional of U.S. Ser. No. 10/346,257, filed Jan. 17, 2003, which claims priority to U.S. Provisional Application No. 60/349,526, filed Jan. 18, 2002. Each of the aforementioned applications is incorporated herein by reference.

### TECHNICAL FIELD

The present invention relates to the field of poultry processing equipment, particularly rotational hub and belt assemblies for de-feathering or plucking devices.

### BACKGROUND

Poultry processing industries commonly use automated lines to kill, eviscerate, pluck and further process birds. Rotational devices are generally employed to facilitate continuity of process and to minimize labor. One of the most common poultry processing machines is a plucker or de-featherer. For many years devices incorporating a number of pliable fingers have been utilized to beat and pull the feathers from bird carcasses.

In processing facilities, multiple finger-type plucking devices are used in sequence to fully pluck a carcass. Typical plucking processes incorporate opposing pairs of finger-typed pluckers which are sufficiently spaced apart to maneuver a bird carcass therebetween. Initial plucking is completed with a pair of spaced-apart finger-type pluckers having a plurality of rigid, spaced-apart fingers. Subsequent plucking of fine feathers is accomplished by passing the bird between opposed pairs of pluckers having multiple pliable fingers. Automated plucking devices are generally used to suspend and move the bird carcass along a line of opposed pairs of pluckers which depilate the carcass of all feathers from course to fine as the carcass travels along the processing line.

Typically, the pluckers of a processing line are powered by a motor which provides rotational force to each plucker via a chain or belt drive assembly. Early assemblies utilized a single motor connected to each plucker hub. This method facilitated accurate control of individual hub speed which is necessary to mesh opposing pairs of hubs and to synchronize sequential hubs. Due to the high cost of purchasing and maintaining individual motors, eventually hubs were spaced-apart in sequence so that a single motor could be used to drive multiple pluckers. Single drive hub assemblies eliminated multiple motors but had several inherent problems.

Either a V-belt or flat belt is used to transfer the rotational force from the motor to each sequentially aligned hub. Hub drives incorporate a smooth pulley commonly used for drive belt applications. The drive belts frequently have to be adjusted to maintain the desired, and necessary pressure and friction between the belt and pulleys to drive the multiple pickers. Problems exist in that the smooth belts stretch and constant maintenance and attention is required to control the drive force. Friction from belt slippage also accelerates wear and tear on hub assemblies, belts and motors.

Efforts to remediate the stated deficiencies resulted in a drive assembly which utilized drive chains and hub sprockets rather than belts and pulleys. This improvement resulted in constant and consistent force transferal from the drive source to the hub assemblies. However, it is common that the poultry being processed, or the shackles from which bird carcasses are suspended, become entangled or otherwise disrupt the plucker assembly. When, for instance, a shackle becomes entangled in single plucker, continual force of the drive source will cause the chain to shear the sprocket of that plucker. Further, problems in the plucking process can result in the jumping, or unwanted movement of the chain in relation to the sequence of hub gear assemblies. Often, hub gears are made of hardened plastic in an effort to minimize the cost incurred by shearing of sprocket teeth. These inexpensive systems are prone to failure and require significant maintenance due, in large part, to the intrusion of dirt, feathers and fecal matter into the moving parts.

Furthermore, poultry processing has conventionally relied upon “V” or flat belt technology, or the chain and gear assembly described above. Both of these assemblies require constant maintenance and adjustment. Because of belt slippage and the friction imparted on a hub assembly by the belt, hubs wear very quickly and must be rebuilt or replaced on a regular basis. Gear and chain drives require constant maintenance and because of shackle entanglement in pluckers result in the shearing of teeth from the sprocket.

### SUMMARY

A poultry processing machine, particularly a hub and belt assembly such as a feather plucking device, facilitates timed rotation of driven members while diminishing wear and breakage commonly associated with such equipment. More particularly the device is a poultry processing apparatus which comprises a hub having a flange portion, a boss portion, a pulley end and a central bore extending therethrough. A hub plate, attachable to the hub, has a flange portion and a hub plate shaft bore alignable with the central bore of the hub. A drive shaft is mounted transversely through the central bore and hub plate shaft bore; the drive shaft further is provided with a pulley end and a spaced-apart drive end. A first bearing is positioned on the drive shaft at the hub plate and a second bearing is positioned on the drive shaft at the junction of the flange portion and boss portion.

Seals adjacent each bearing limit intrusion of foreign matter into the workings of the hub assembly. The seals, along with the configuration of pulleys and belts, may limit required maintenance and component replacement. A seal is for example positioned adjacent each bearing and at the hub plate to effectively prevent foreign matter from wearing the drive shaft and bearings.

A drive belt operatively connects to a pulley fastened to the drive shaft at the pulley end and to a spaced-apart drive source. A poultry defeathering device, such as pliable rubber fingers, attaches to the drive shaft at the drive end and rotation of the drive belt about the pulley spins the drive shaft in the first bearing, second bearing and third bearing within the hub housing, thereby operatively rotating the poultry defeathering device.

Designed primarily for ganged sets of plucking arms, the hub and belt system may include a heat dissipating hub housing journalled to a drive shaft, preferably with at least two independent sealed bearings, and a timing belt which allows operators to alternate time opposed pairs of plucker arms to avoid entanglement of the process poultry, hangers and the plucking heads.

In one embodiment, a poultry processing apparatus includes at least one hub, and a drive shaft mounted transversely through the at least one hub. The drive shaft has a pulley end and a drive end. At least one sealed bearing is received on the drive shaft and rotationally supports the at least one hub. A pulley attaches to the pulley end of the drive shaft. A drive belt operatively connects the pulley to a drive source.

In one embodiment, a poultry processing apparatus includes a hub having a flange portion, a boss portion, a pulley end and a central bore extending therethrough. A hub plate attachable to the hub has a flare portion and a hub plate shaft bore alignable with the central bore of the hub. A drive shaft, mounted transversely through the central bore and hub plate shaft bore, has a pulley end and a spaced-apart drive end. A first bearing and a seal are positioned on the drive shaft at the hub plate, and a second bearing and a seal are positioned on the drive shaft at the junction of the flange portion and boss portion. A drive belt operatively connects to a pulley fastened to the drive shaft at the pulley end and to a spaced-apart drive source. A poultry defeathering device attaches to the drive shaft at the drive end. Rotation of the drive belt about the pulley spins the drive shaft in the first bearing and second bearing within the hub housing, thereby operatively rotating the poultry de-feathering device.

In one embodiment, a poultry processing apparatus includes at least one hub with a first end and a second end. A hub plate provided at the first end has an annular insert flare for mating to a machine cabinet opening. A drive shaft, having a pulley end and a drive end, mounts transversely through the hub. At least two sealed bearings rotationally support the at least one hub. One sealed bearing is positioned at each end of the hub, to provide a seal between the hub end and the drive shaft. A seal mounts to the first end of the hub at the annular insert flare. A pulley attaches to the pulley end of the drive shaft, and a drive belt operatively connects the pulley to a drive source.

Another embodiment is directed to a hub and belt assembly for driving a poultry de-feathering machine. This hub and belt assembly includes a multiple bearing heat dissipating hub that includes bearing isolators or spacers associated with each of the drive shaft bearings. The bearing isolators trap vapors, including water and the like that may accumulate from operation of the hub and belt assembly, and prevent this vapor from contacting the bearings. As such, degradation of the bearings is inhibited.

Another embodiment is directed to a poultry processing apparatus. The apparatus includes at least one hub including a housing, the housing including a first end and a second end and an interior chamber or central bore. There is a drive shaft mounted transversely through the housing. The drive shaft extends through the interior chamber, and has a first end and a second end corresponding to the first end and the second end of the housing. There is at least one, and for example, two sealed bearings received on each of the ends of the drive shaft. The bearings rotationally support the drive shaft in the interior chamber of the hub. For each sealed bearing, there is a bearing isolator received on the drive shaft between each respective sealed bearing and the respective end of the housing, the bearing isolators are least partially within the interior chamber.

### BRIEF DESCRIPTION OF THE DRAWINGS

Attention is now directed to the drawing figures, where corresponding or like numerals or characters indicate corresponding or like elements 4 or components. The drawing figures are as follows.

FIG. 1 is a perspective side view of one embodiment of the inventive device.

FIG. 2 is a perspective view of one inventive hub assembly.

FIG. 3 is a sectional view of the inventive hub assembly taken along line 3 of FIG. 2.

FIG. 4 is a perspective view of another embodiment of the inventive hub assembly.

FIG. 5 is a perspective view of another embodiment of the inventive hub assembly.

FIG. 6 is a perspective view of yet another embodiment of the inventive hub assembly.

FIG. 7 is a perspective view of another embodiment of the inventive hub assembly.

FIG. 8 is a cross sectional view of an alternate hub for a hub assembly, such as that of FIG. 2, directly mounted to a machine cabinet.

FIG. 9 is cross sectional view of the hub of FIG. 8 attached to a machine cabinet.

FIGS. 10A and 10B are perspective views of the hub assembly of FIG. 9 with cut-away portions showing the inside of the housing.

FIG. 11 is cross sectional view of the hub of FIG. 8 in an alternate attachment to a machine cabinet.

FIGS. 12-14 are cross sectional views of the hub assembly of FIG. 9 accommodating various pulleys.

### DETAILED DESCRIPTION

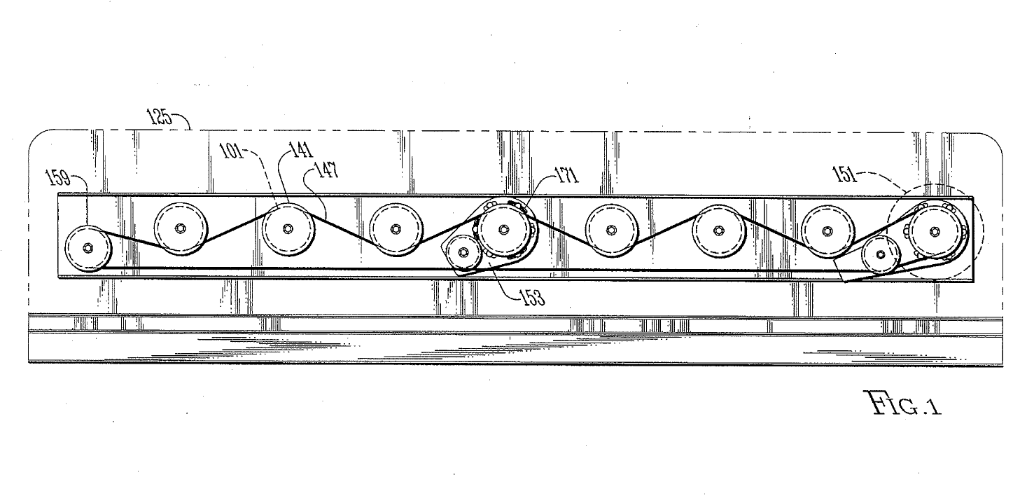

The assembly described herein efficiently rotates a gang of poultry processing equipment. An embodiment of a hub 101 and belt 147 assembly for rotating processing equipment is generally shown in FIG. 1.

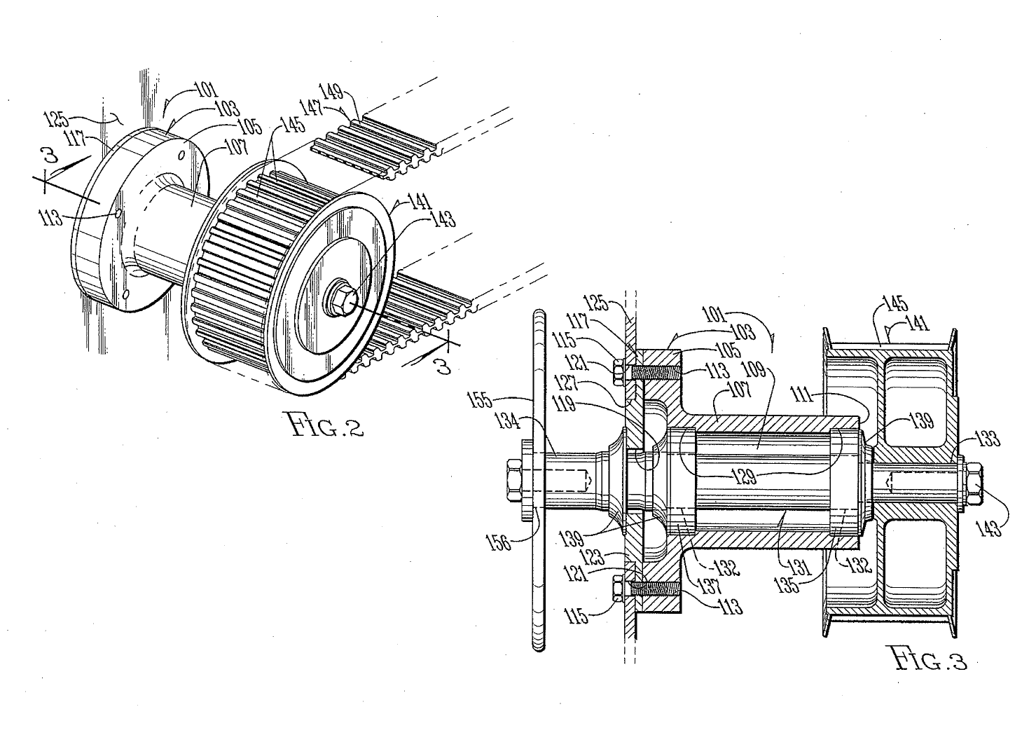

Referring now to FIGS. 1, 2 and 3, hub 101 includes a hub housing 103 having a flange portion 105, a boss portion 107 projecting laterally from one side of the flange portion 105 terminating at a pulley end 111, and a central bore 109 extending through the flange 105 and boss 107 along the general axis of the hub. The flange portion 105 may include a plurality of circumferentially oriented mounting holes 113 for attaching the hub 101 to a machine cabinet 125, for example with screws or threaded bolts 115. A separate hub plate 117 is mountable to the hub housing 103 at the flange portion 105 opposite the boss portion 107. The hub plate 117 has a shaft bore 119 aligned with the central bore 109 and is further provided with a plurality of circumferentially oriented hub plate mounting holes 121 alignable with the mounting holes 113 of the flange portion 105. Hub housing 103 and hub plate 117 are for example manufactured of material which rapidly and efficiently dissipates heat, such as aluminum.

Multiple outer bearing races 129 are formed within the central bore 109, preferably at the pulley end 111 of the boss portion 107, at the hub plate 117 attachment position and adjacent the junction of the flange portion 105 and boss portion 107. A drive shaft 131 is positioned through the central bore 109 of the hub 101 and the hub plate shaft bore 119. Multiple inner bearing races 132 on the drive shaft 131 coincide with the outer bearing races 129 of the central bore 109 and the hub plate shaft bore 119. Sealed bearings 135 and 137 fit at each inner race 132 and outer race 129 to fasten the drive shaft 131 axially through the central bore 109 and hub plate shaft bore 119, while allowing the drive shaft 131 to freely rotate within the hub 101. A first bearing 135 is for example positioned at the pulley end 111 of the hub housing 103, and a second bearing 137 positioned substantially near the junction of the flange portion 105 and boss portion 107. Additional bearing positions may be used depending on the size and application of the hub assembly.

Hub seals 139 are positioned on the drive shaft 131 adjacent each bearing 135 and 137. A seal 139 may also be mounted adjacent the hub plate 117 to prevent dirt and debris from invading the juncture of the drive shaft 131 and the hub plate 117. The combination of three seals 139 provides a near hermetic seal which eliminates invasion of feathers, feather parts, dirt, fecal matter and the like into the hub assembly.

The separate hub plate 117 has an insert flange 123 which has an outer circumference equal to the circumference of a machine cabinet opening 127 where the hub 101 is to be attached. This insert flange 123 for example provides a loose seal between the hub 101 and the machine cabinet 125, to diminish vibration and wear common in rotating processing equipment. The placement of a seal 139 on the drive shaft 131 at the insert flange 123 limits internal wear caused by the dust, feathers and debris inherent with the depilating process.

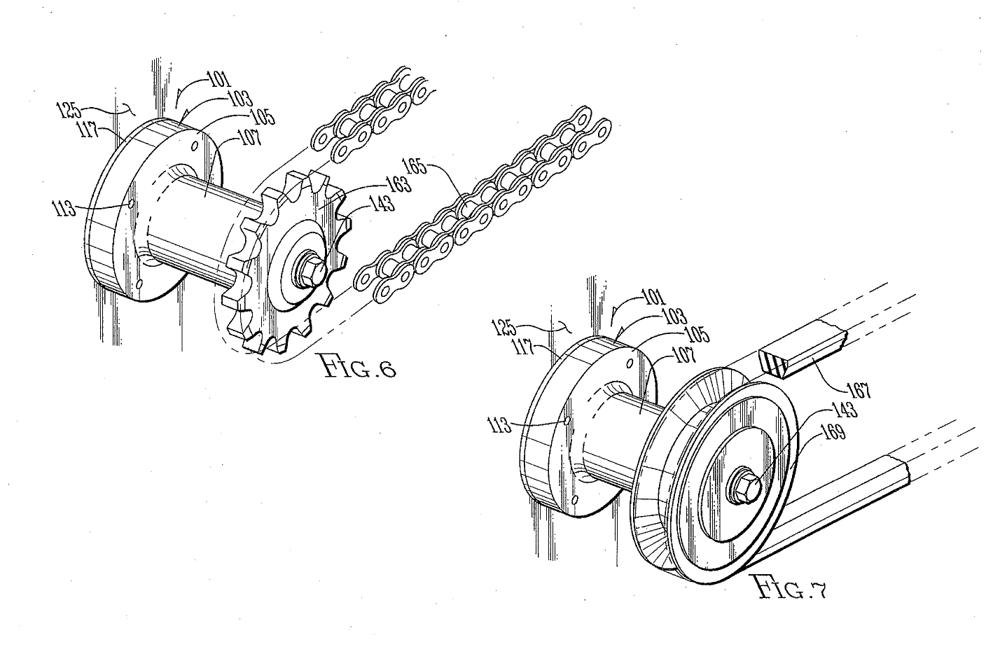

A pulley 141 is fastened, via a pulley attachment device 143, at a pulley end 133 of the drive shaft 131 adjacent the pulley end 111 of the hub housing 103. The pulley 141 includes a plurality of spaced-apart timing serrations 145. A timing belt 147 with a plurality of spaced apart serrations 149, which mate to the pulley serrations 145, connects the drive shaft 131 to a drive mechanism 151. Timing belt 147 and serrated pulley 141 may eliminate belt slippage common with poultry processing equipment powered with a flat or V-shaped belt. A second type of timing belt 147, as shown in FIG. 4, may be used in place of the serrated belt.

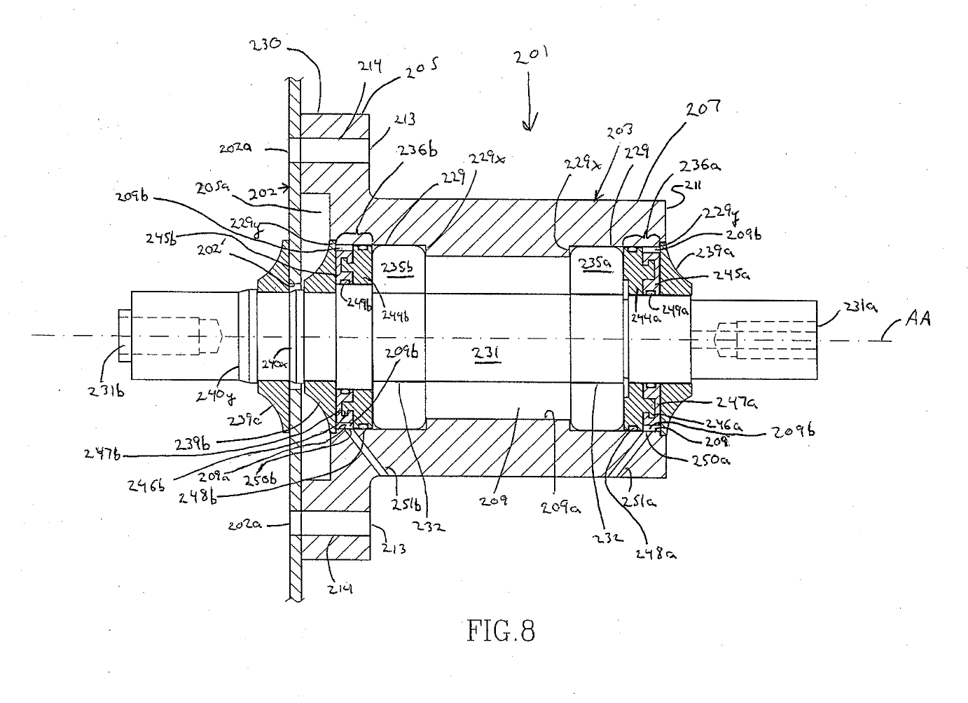

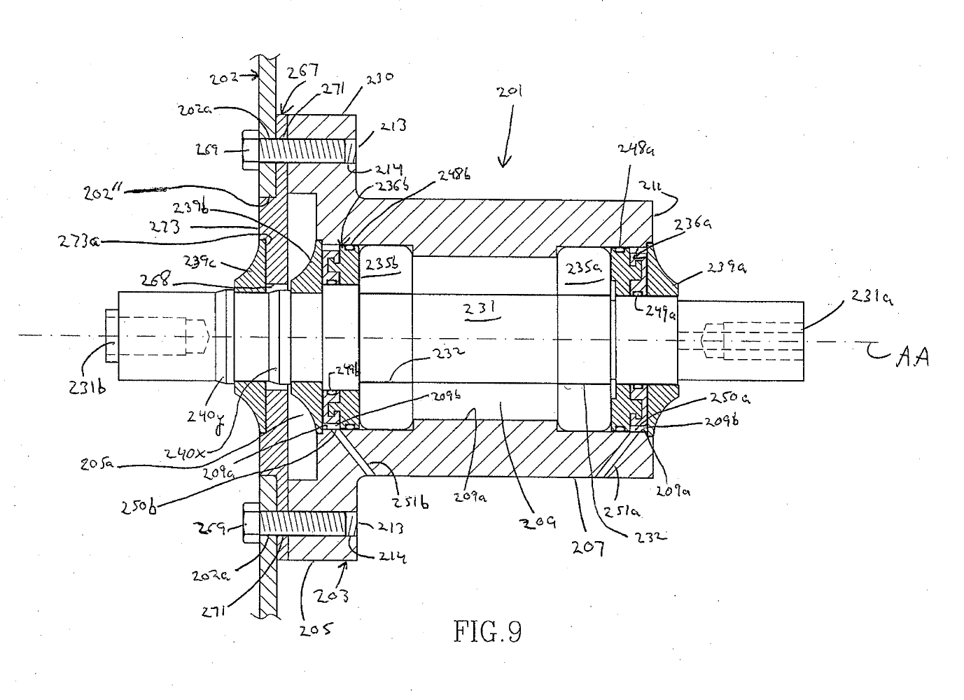

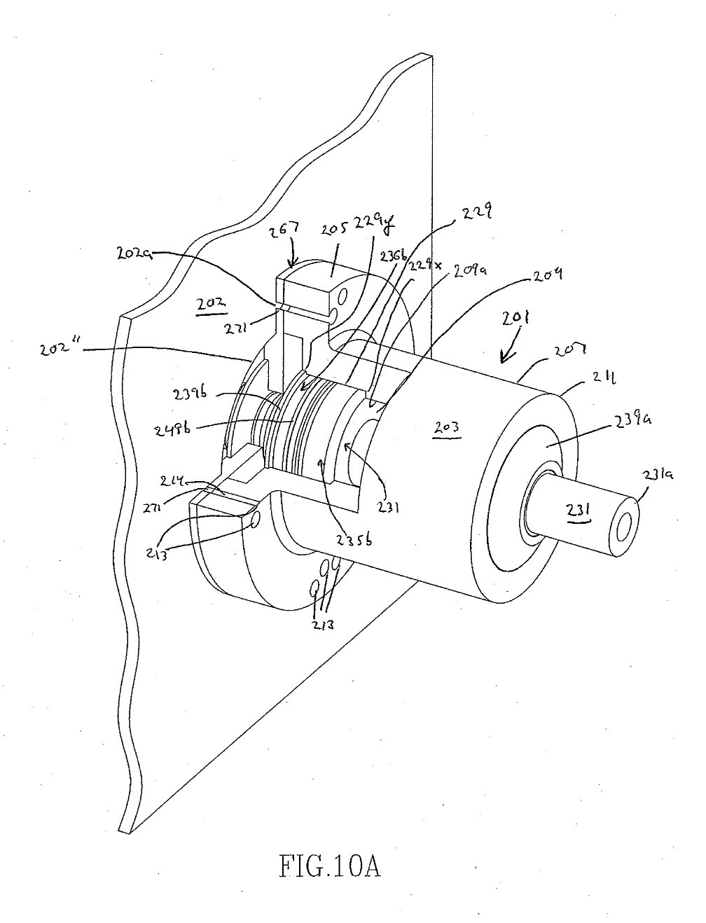

As best shown in FIGS. 5 and 7, the pulley 141 may be exchanged with a common pulley for use with a flat or V-shaped belt if desired, or in necessary situations such as when a timing belt is not available. If preferred, a user may exchange the pulley 141 with a gear 163 which can be driven with a chain 165 as shown in FIG. 6. The user thus has a triple drive option because he or she may drive the rotational device using a timing belt 147, flat 162 or V-belt 167, or chain 165 by alternating the drive shaft 131 attachment with a serrated pulley 141, common “V” pulley 169 or flat pulley 161.

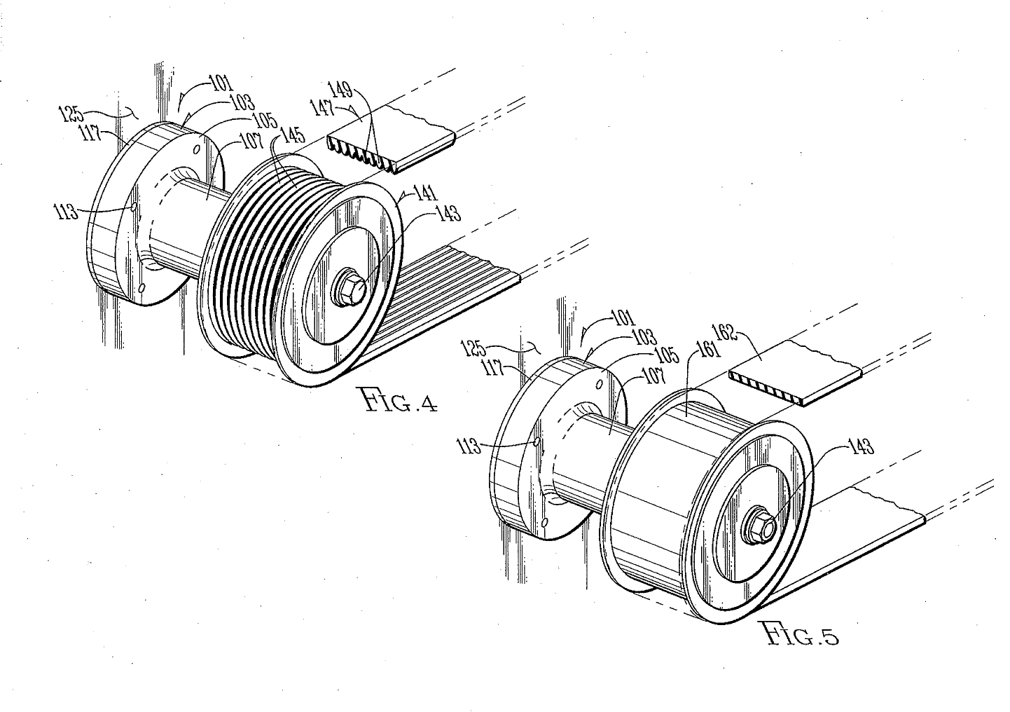

A finger plate bore 156 is formed in a drive end 134 of the drive shaft 131 opposite the pulley end 133. For a defeathering device, a finger plate 155 is bolted into the finger plate bore 156. The finger plate 155 can be provided with a plurality of plucking fingers, e.g., plucking finger 171 (see FIG. 3), as is common in the industry.

As best shown in FIG. 1, the hub and belt assembly may power a series of driven rotational defeatherers. The drive mechanism 151 and a belt return hub 159 are positioned at opposite ends of a series of substantially aligned hubs 101. A timing belt 147 encircles the drive mechanism 151 and return hub 159, and alternates above and below each sequential hub pulley 141. At least one spring-loaded tension arm and idler pulley 153 may be provided at least at one hub 101 to independently release belt tension should the finger plate 155, or any part of the plucker assembly, become jammed.

The series of hub and belt assemblies for example utilizes a timing belt having two sides, each side provided with spaced-apart protruding serrations. The belt (e.g., timing belt 147) alternates above and below each of the aligned pulleys.

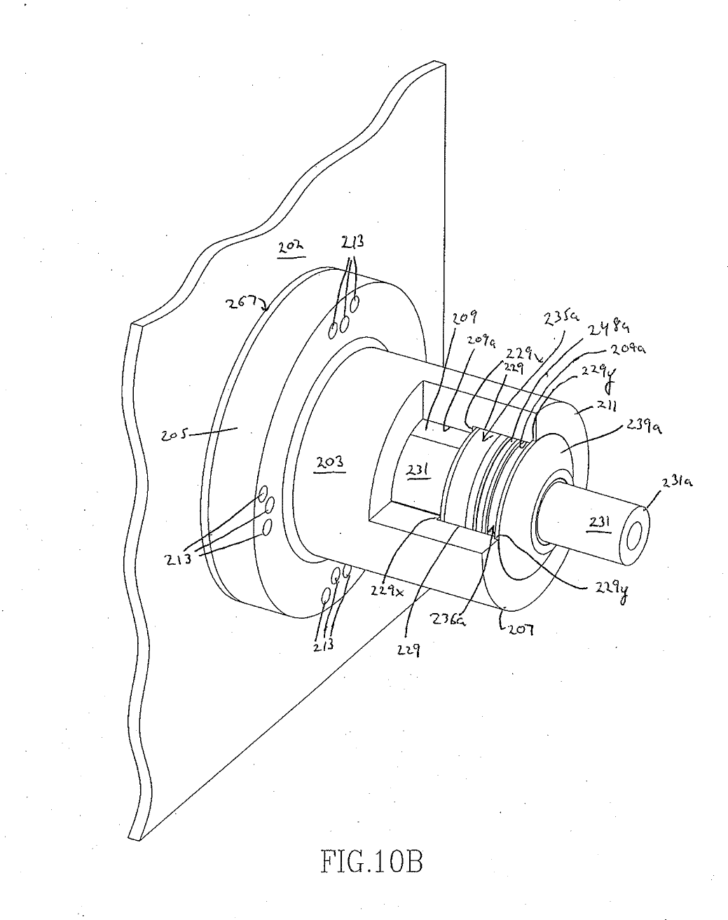

Referring now to FIG. 8, there is shown an alternate embodiment hub 201 of the hub 101, shown in FIGS. 1-7 and described above. In this alternate hub 201, components similar to these for hub 101 have been increased by “100” (and are numbered similarly in the 200's). These similar components have been described above, and their descriptions are applicable for the hub 201. Other components, not part of the hub 101 are numbered differently and detailed below.

For example, the hub 201 is shown mounted directly to a machine cabinet 202. The machine cabinet is identical or similar to the machine cabinet 125 detailed above. This cabinet 202 includes an opening 202′ for accommodating the drive shaft 231 of the hub 201.

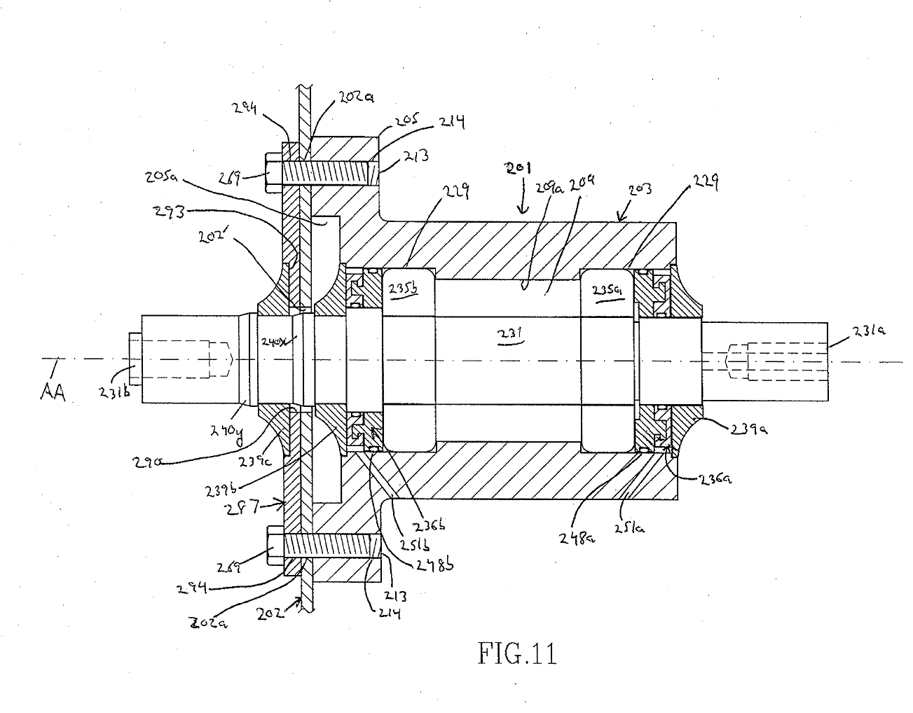

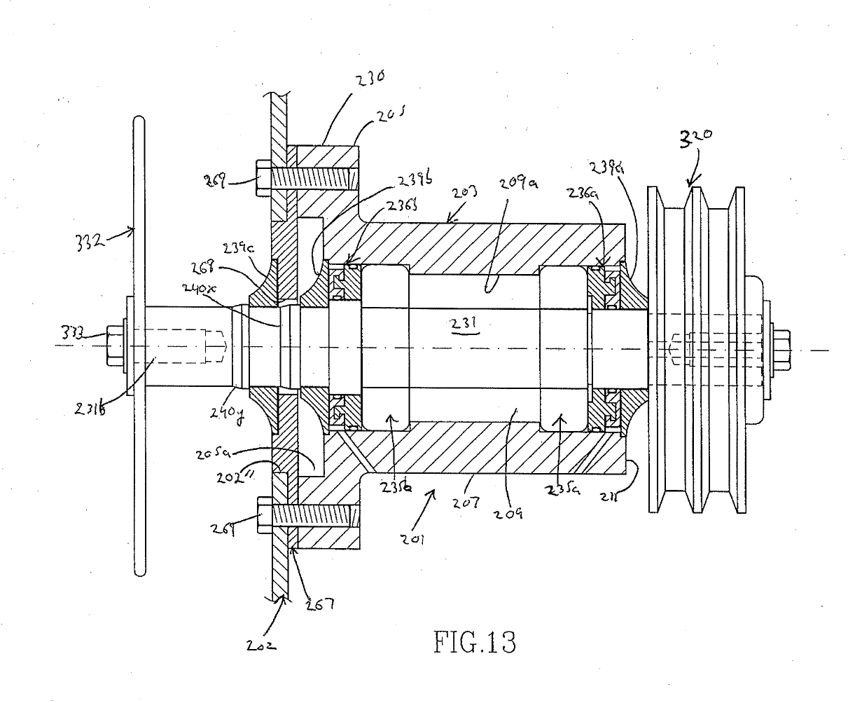

The hub 201 includes housing 203 having a flange portion 205, a boss portion 207 projecting laterally from one side of the flange portion 205 terminating at a pulley end 211, and a central bore 209 extending through the flange 205 and boss 207 along the general (transverse) axis AA of the hub 201. The flange portion 205 may include a plurality of circumferentially oriented mounting holes 213 for attaching the hub 201 to a machine cabinet 202 (FIGS. 9 and 11), for example with screws 269 (FIGS. 9 and 11-14) or threaded bolts. The plurality of mounting holes 213 (that extend into threaded bores 214) allows for fits with the cabinet bolt spacing of numerous manufacturers.

The flange portion 205 and boss portion 207 are typically integral as the housing 203 is, for example, a single piece. For example, the housing 203 is formed by machining an aluminum billet. Aluminum is one of several materials suitable for the housing 203, as it allows for heat dissipation from the central bore 209 of the housing. The flange portion 205 may also include an open area 205a, that defines a space between the flange portion 205 and the machine casing 202 (FIGS. 8 and 11 or the flange portion 205 and the plate 267 (FIGS. 9, 10A, 10B and 12-14).

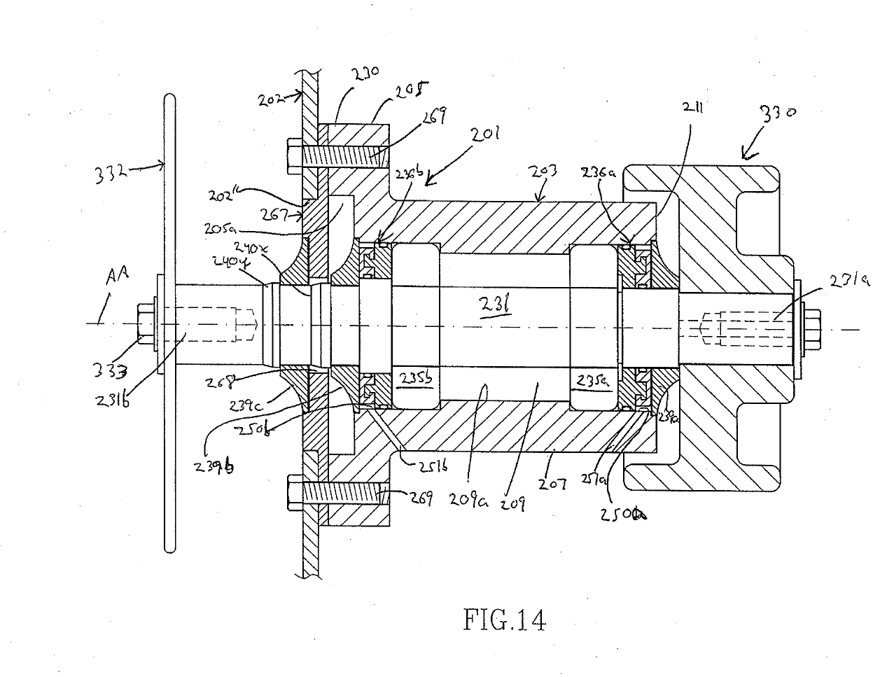

Multiple outer bearing races 229 are formed within the central bore 209, at the pulley end 211 of the boss portion 207, and at the opposite end 230 of the boss portion 207, adjacent the junction of the flange portion 205 and boss portion 207. A drive shaft 231 is positioned through the central bore 209 of the hub 201. Multiple inner bearing races 232 on the drive shaft 231 coincide with the outer bearing races 229 of the central bore 209 and the hub plate shaft bore 219. The drive shaft 231 includes axial openings 231a, 231b at its opposite ends, to accommodate the attachment of, for example, pulleys 310, 320, 330 (FIGS. 12-14) (via opening 231a) and finger plates 332 (FIGS. 12-14) (via opening 231b).

Sealed bearings 235a, 235b (similar to bearings 135, 137), for example, of stainless steel, and their respective bearing isolators or spacer 136a, 136b fit at each inner race 232 and outer race 229 to fasten the drive shaft 231 axially through the central bore 209, while allowing the drive shaft 231 to freely rotate within the hub 201. A first bearing 235a and bearing isolator 236a, are for example positioned at the pulley end 211 of the hub housing 203, and a second bearing 235b and bearing isolator 236b are positioned substantially near the junction of the flange portion 205 and boss portion 207. The bearings 235a, 235b abut against the inward shoulders 229x of the outer bearing races 229, that serve as stop surfaces. Additional bearing positions may be used depending on the size and application of the hub 201. The bearing isolators 236a, 236b serve to trap vapors, to prevent these vapors from entering the bearings 235a, 235b and degrading the bearings 235a, 235b.

Hub seals 239a, 239b, also known as slinger seals, are positioned on the drive shaft 231 adjacent each bearing isolator 236a, 236b, an in abutment with an outward shoulder 229y of the outer bearing races 229, in which the hub seals 239a, 239b seat. The hub seals 239a, 239b prevent dirt and debris from invading the juncture of the central bore 209 and causing degradation of the bearings 235a, 235b. These hub or slinger seals 239a, 239b provide a near hermetic seal which eliminates invasion of feathers, feather parts, dirt, fecal matter and the like into the hub 201. The hub seals 239a, 239b are, for example, made of an elastomeric material.

Hub seal 239a is maintained on its outer (smaller diameter end) by the abutment of a pulley or other retaining structure on the drive shaft 231 (not shown). Hub seal 239b is maintained on its outer (smaller diameter end) by the abutment with a protruding ridge 240x on the drive shaft 231. In this mounting arrangement of FIG. 8, there is an additional hub seal (slinger seal) 239c that is in abutment with the machine cabinet 202. This hub seal 239c is similar in construction and materials to hub seals 239a, 239b and like hub seal 239b, is maintained on its outer (smaller diameter end) by the abutment with a protruding ridge 240y on the drive shaft 231.

The bearing isolators 236a, 336b are, for example, formed of ring portions 244a, 245a, 244b, 245b. The ring portions 244a, 245a, 244b, 245b are coaxial and movably engaged with each other, as a peripheral tongue 246a, 246b on the respective ring portion 244a, 244b is slidably engaged in a correspondingly shaped groove 247a, 247b in the respective ring portion 245a, 245b. This configuration allows each ring portion 244a, 244b to be rotatable with respect to the other ring portion 245a, 245b.

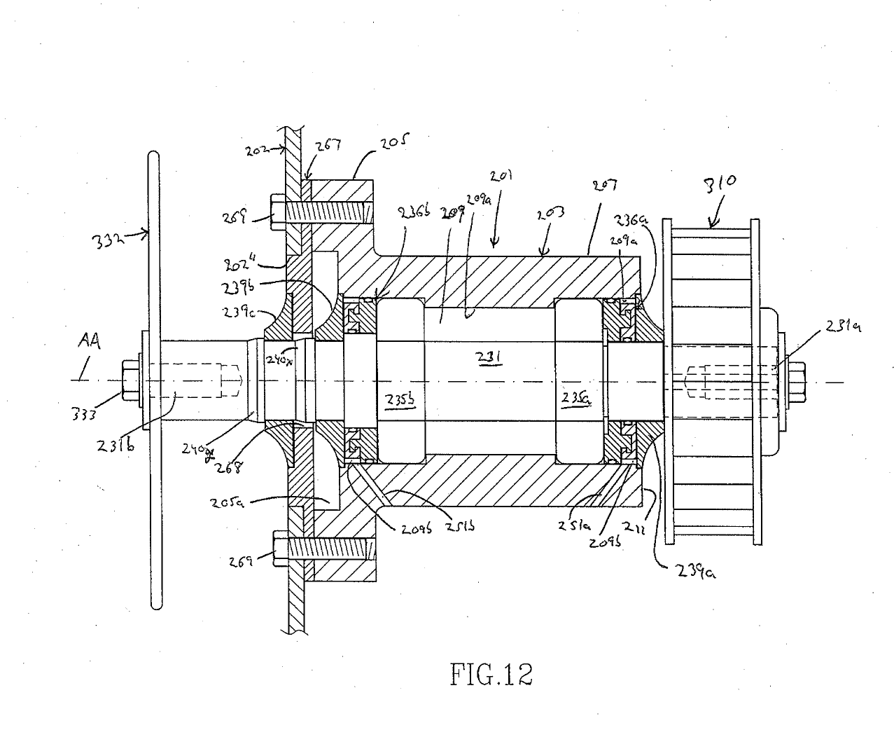

The ring portions 244a, 244b include an O-ring 248a, 248b on their outer sides, that frictionally contacts the inner wall 209a of the central bore 209, to serve as a seal against water, condensate and other debris (and also shown in FIGS. 10A and 10B). The ring portions 245a, 245b include an O-ring on their inner sides 249a, 249b, that frictionally contacts the outer surface of the drive shaft 231, to serve as a seal against water, condensate and other debris. The ring portions 244a, 245a, 244b, 245b, are, for example, of a polymeric material or plastic. The O-rings 248a, 248b, 249a, 249b are, for example, of an elastomeric material such as silicon or the like. The ring portions 244a, 245a, 244b, 245b are such that the portions 244a, 244b are of a slightly greater diameter than portions 245a, 245b, such that there is a small space 209b, formed between the O-rings 248a, 248b, ring portions 245a, 245b and inner wall 209a of the central bore 209, where condensate can accumulate, such that when the hub 201 cools, becomes water.

For example, a bearing isolator suitable for use in the hub 201 as the bearing isolator 236a is commercially available as Part No. JM LWM-0250-0520-AY67 from Parker Hannifin Corporation, EPS Division, Salt Lake City, Utah. For example, a bearing isolator suitable for use in the hub 201 as the bearing isolator 236b is commercially available as Part No. JM LWM-0300-0520-AY66 from Parker Hannifin Corporation, EPS Division, Salt Lake City, Utah.

Weep holes 250a, 250b in the inner wall 209a of the central bore 209, extend into bores 251a, 251b, that extend through the housing 203, providing a pathway for water from the spaces 209b to outside of the housing 203. The bores 251a, 251b are, for example, angled, to facilitate movement of water out of the housing 203. While two weep holes 250a, 250b and bores 251a, 251b are shown, this is exemplary only, as any number of weep holes and bores is permissible. Accordingly, water will not build up in the housing 203, and thus degradation of the components in the housing 203 is inhibited.

Turning also to FIGS. 9, 10A and 10B, there is shown the hub 201 connected to a machine cabinet 202 (similar to the machine cabinet 125 detailed above). The connection of the hub 201 involves a separate hub plate 267 that is mountable to the hub housing 203 at the flange portion 205 opposite the boss portion 207. The hub plate 267 has a shaft bore (or opening) 268 aligned with the central bore 209 and is further provided with a plurality of circumferentially oriented hub plate mounting holes 271 alignable with the selected mounting hole of the mounting holes 213 of the flange portion 205. Screws or bolts 269 extend from openings 202a in the cabinet 202 through openings 271 in the hub plate 267 and openings 213 in the flange portion 205 of the housing 203, such that the hub 201 connects to the machine cabinet 202.

The separate hub plate 267 has an insert flange 273 which has an outer circumference equal to the circumference of opening 202″ of the machine cabinet 202 where the hub 201 it to be attached. This hub plate 267, for example, provides a loose seal between the hub 201 and the machine cabinet 202, for stabilization, and to diminish vibration and wear common in rotating processing equipment. A slinger seal 239c (identical or similar to hub or slinger seals 239a, 239b, detailed above) seats on the drive shaft 231 between protruding ridges 240x, 240y (ridge 240x also serves as a stop surface for seal 239b). The slinger seal 239c seats in an indented portion 273a of the insert flange 273. This seating and connection to the drive shaft 231 of the slinger seal 239c, limits internal wear caused by the dust, feathers and debris inherent with the depilating process. This plate 267 is made of, for example, aluminum, identical or similar to that of the housing 203.

Attention is now directed to FIG. 11, which is similar to FIG. 9, except that the hub plate 287 (similar to hub plate 267) is on the other side of the machine cabinet 202. This alternate placement occurs when the machine cabinet 202 has an opening 202′ of a diameter only slightly greater than the diameter of the drive shaft 231. The hub plate 287 has a central opening 290 corresponding and coaxial with the opening 202′ of the machine cabinet 202. The hub plate 287 also includes an indented portion 293 in which the slinger seal 239c seats. Screws or bolts 269 extend from hub plate 287 (openings 294), through the cabinet 202 (openings 202a) and the flange portion 205 (openings 213) of the housing 203, such that the hub 201 connects to the machine cabinet 202.

Attention is directed to FIGS. 12-14, that show exemplary pulleys that may be used with the hub 201 detailed above and the hub assemblies of FIGS. 9, 10A and 10B, and 11. The hub assemblies of FIGS. 12-14 are those of FIGS. 9, 10A and 10B. The pulleys (that are driven by drive sources detailed above) that are utilized may be, for example, a timing belt pulley 310 (FIG. 12), a double V-belt pulley 320 (FIG. 13) or V-belt pulley, and a flat belt pulley 330 (FIG. 14). The pulleys 310, 320, 330 attach at an end of the drive shaft 231 proximate to the opening 231a. The other end of the drive shaft 231 is, for example, attached to a finger plate 332 (identical or similar to the finger plate 155 detailed above), by a bolt 333, screw or the like.

Additional variations and embodiments other than those specifically enumerated may be made to the hub and belt assembly without departing from the spirit and scope of the disclosed subject matter. Therefore, it is intended that the disclosed subject matter not be limited to the disclosed embodiments, but only by the scope of the appended claims.

What is claimed is:

1. A poultry processing apparatus, comprising:
at least one hub including a housing, the housing including a first end and a second end and an interior chamber;
a drive shaft mounted transversely through the housing and extending through the interior chamber, the drive shaft including a first end and a second end corresponding to the first end and the second end of the housing;
at least one sealed bearing received on the drive shaft and rotationally supporting the at least one hub in the interior chamber; and,
a least one bearing isolator received on the drive shaft between the at least one sealed bearing and at least one end of the housing, at least partially within the interior chamber.

2. The apparatus of claim 1 wherein at least one sealed bearing includes two sealed bearings disposed on opposite ends of the drive shaft, and the at least one bearing isolator includes two bearing isolators, each bearing isolator between a sealed bearing and an end of the housing.

3. The apparatus of claim 2, additionally comprising a first seal at a first end of the housing received on the drive shaft in communication with the bearing isolator and a second seal at a second end of the housing received on the drive shaft in communication with the bearing isolator.

4. The apparatus of claim 3, additionally comprising at least one bore extending through housing in communication with the interior chamber and the external environment from each of the bearing isolators to the end of the housing.

5. The apparatus of claim 4, wherein the bores are angled with respect to the axis of the housing.

6. The apparatus of claim 1, wherein the housing is formed from an aluminum billet.

7. The apparatus of claim 1, additionally comprising a pulley received on the first end of the drive shaft.

8. The apparatus of claim 7, wherein the pulley is in communication with a drive source.

9. The apparatus of claim 1, additionally comprising a finger plate attached to the second end of the drive shaft.

10. The apparatus of claim 8, wherein the pulley is configured for receiving a drive belt is selected from the group consisting of: a timing belt, a flat belt and at least one V-belt.
